(19) United States
(12) Patent Application Publication
(10) Pub. No.: US 2003/0078868 A1
(43) Pub. Date: Apr. 24, 2003

(54) Process and equipment therein collaboratively create value for e-business

(76) Inventors: Ruey-Tong Cheng, Taipei City (TW); Chien-Ke Cheng, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/983,131

(22) Filed: Oct. 23, 2001

(51) Int. Cl. G06F 17/60

(52) U.S. Cl. 705/36

(57) ABSTRACT

The present invention is related to a process and equipment therein, which are a type of enterprise built on wire or wireless communication platform (such as Web site) with the enterprise value collaboratively created by investors, operators and users through the interactions between the users in the electronic communication environment built by the investors and the operators. The enterprise will make records and allocations by appropriate amount of virtual currency according to the actual contributions from the three parties. When the e-company is transformed, sold or has resolutions, the generated interests will be allocated to the three parties according to the calculation formulas or the proportion of the accumulated quantity of virtual currency or measuring units, so the investors, the operators and the users can benefit from the mechanism.

### BACKGROUND OF THE INVENTION

1. FIELD OF THE INVENTION

This invention is related to a process and equipment therein to collaboratively create value for e-business. Especially it means a process and equipment therein that can collaboratively create value for e-business through the interactions among the enterprises and users.

2. Description of the Prior Art

Generally, e-business is managed by web operators, who put a lot of efforts in updating the web contents to attract the web users and maintain the web operation with income from on-line transactions or advertisements. Such a painstaking task does not necessarily guarantee a satisfactory number of web visitors, so it is often heard that some web companies have difficulties to survive.

Therefore, the traditional e-business management has many shortcomings because the business model is usually not well designed and needs to be improved.

In view of the above shortcomings for the traditional e-business therein, the inventor is eager to seek improvement and innovations. After many years of dedication to this subject, the inventor eventually makes such an accomplishment that can provide a process and equipment therein to collaboratively create value for e-business.

### SUMMARY OF THE INVENTION

The object of this invention is to provide a process and equipment therein for investors, business operators and users to create value for e-business collaboratively. At first, the investors and the business operators establish the electronic communication environment for e-business, in which the users that browse the contents, advertise, provide contents and upload photos, voices and pictures and other multimedia are recognized as sponsors, who will be rewarded of the generated value according to their practical contribution measured by virtual currency or calculation formulas. When the e-company is registered to IPO, raises capital, is set for sale or is in a resolution process, the interests created will be distributed to the investors, the operators and the users according to proportion or calculation formulas.

The process and equipment therein to attain the above object that can collaboratively create value for e-business are established by the investors and the operators. Meanwhile, the users can use all kinds of terminal devices or browsers to enhance the value for e-business through the communication network and interactions with other e-companies on the web.

### BRIEF DESCRIPTION OF THE DRAWINGS

The drawings disclose an illustrative embodiment of the present invention which serves to exemplify the various advantages and objects hereof, and are as follows:

FIG. 1 is the illustrative framework for the present invention to collaboratively create value for e-business.

FIG. 2(a) is the value-added illustration for the present invention to collaboratively create value for e-business.

FIG. 2(b) is the value-added illustration for the present invention to collaboratively create value for e-business.

FIG. 2(c) is the value-added illustration for the present invention to collaboratively create value for e-business.

FIG. 3 is the income distribution chart in currency unit from the sale of the e-company.

FIG. 4 is the illustration for determining the distribution ratios of stock option when it is registered to be a listed company.

FIG. 5 is the illustration for determining the rights when the e-company becomes a website with public credibility.

### DETAILED DESCRIPTION OF THE PREFERRED EMBODIMENT

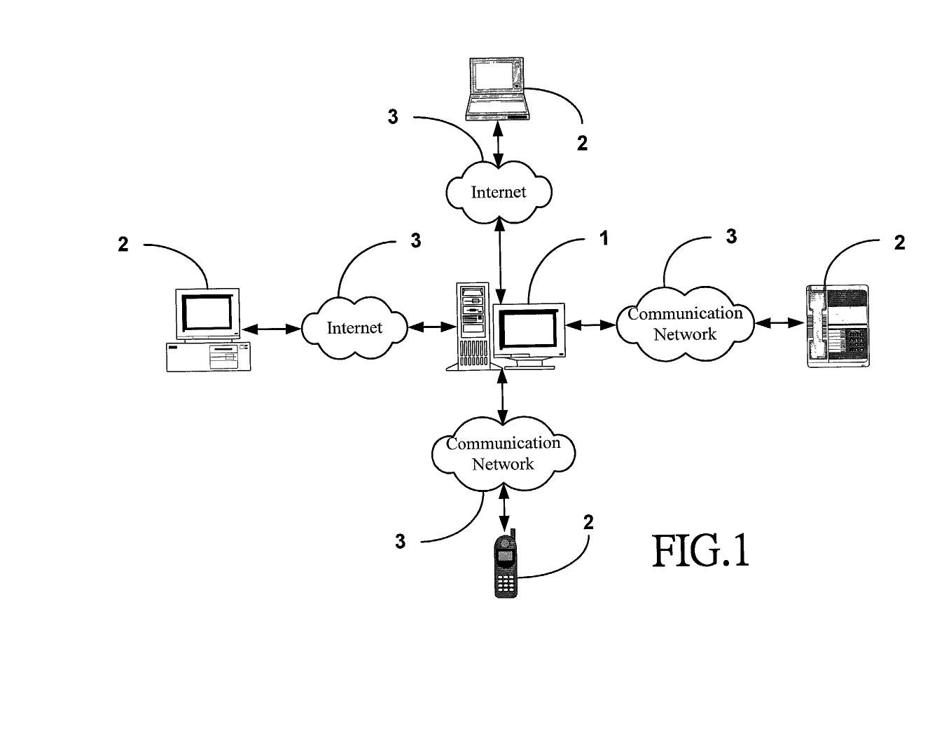

Please refer to FIG. 1, which is the illustrative framework for the present invention to collaboratively create value for e-business. It is known from the figure that the investors and the operators spend money and efforts to establish a website, a server and an exchange platform 1 and attract users from everywhere to use terminal devices or browsers 2 through Internet and communication network 3 to browse the contents, put advertisements, provide contents, upload pictures and photos and provide voices, music, images or other multimedia on the platform. All investors, operators and users are considered as contributors to the network platform. The business will account their respective contribution calculated by predetermined formulas in the virtual currency eNetDollar (eNet$, |$\e|) or other measuring units according to each individual account on the network platform. When the e-company is registered to IPO or raising capital, the stock option will be distributed to all contributors in nominal value or below market price according to the proportion based on the respective account balance or predetermined calculation formulas. When the network platform ownership is wholly or partially sold, the interests created will be distributed to all contributors according to proportion or predetermined calculation formulas. The interests generated from resolution rights will be allotted proportionally or based upon the calculation formula.

As a result of the implementation of the process and the equipment in the present invention that can collaboratively create value for e-business, the generated interests include currency, stock option (including other interests created) and resolution rights, the ratio of all these kinds of interests to the investment is called Earn Per Dream (EPD).

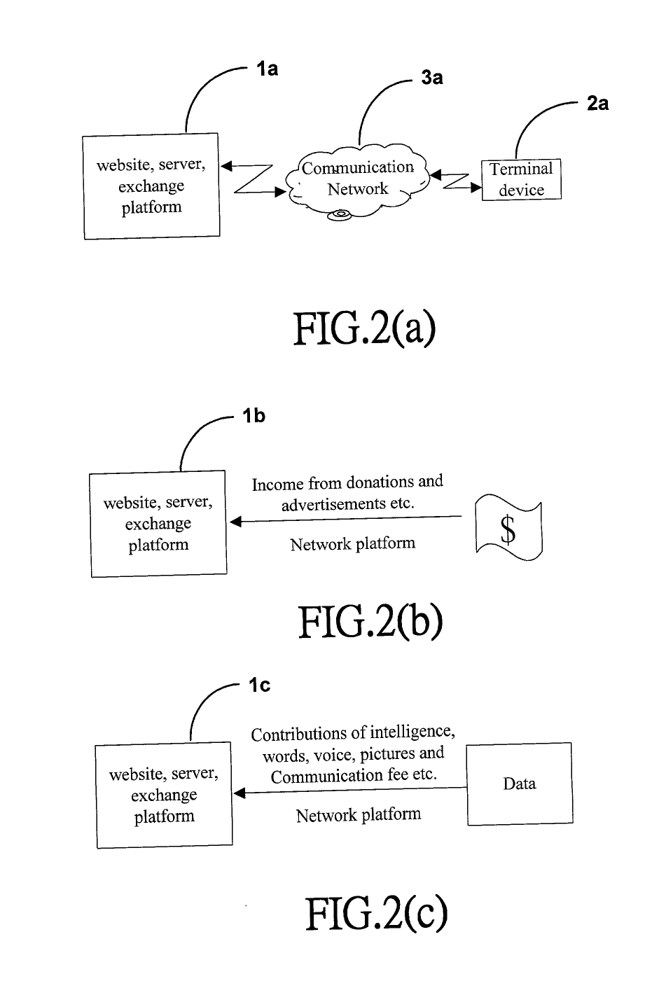

Please refer to FIG. 2(a), FIG. 2(b) and FIG. 2(c), which the value-added illustrations for the present invention to collaboratively create value for e-business. The contributors can increase eNetDollar in their accounts by the following ways.

1. As shown in FIG. 2(a), users can use terminal devices or browsers 2a through Internet or communication network 3a to log on the network platform or exchange platform 1a to browse or transfer data. The network platform will register the user information and increase eNetDollar in their accounts.

2. As shown in FIG. 2(b), when users put advertisements on the website or exchange platform 1b and make the payment, the website or exchange platform 1b will recognize contributions from the users and increase eNetDollar or points in their accounts; when users make donations to the website or exchange platform 1b, they are also considered contributory to the platform and eNetDollar and points in their accounts will also be increased.

3. As shown in FIG. 2(c), when users make contributions by uploading legitimate articles, pictures, photos, voices, music, images and other multimedia to the website or exchange platform 1c, even just look-through website or contact with exchange platform 1c, the website or exchange platform 1c will evaluate the contributions and reward the users with eNetDollar or points.

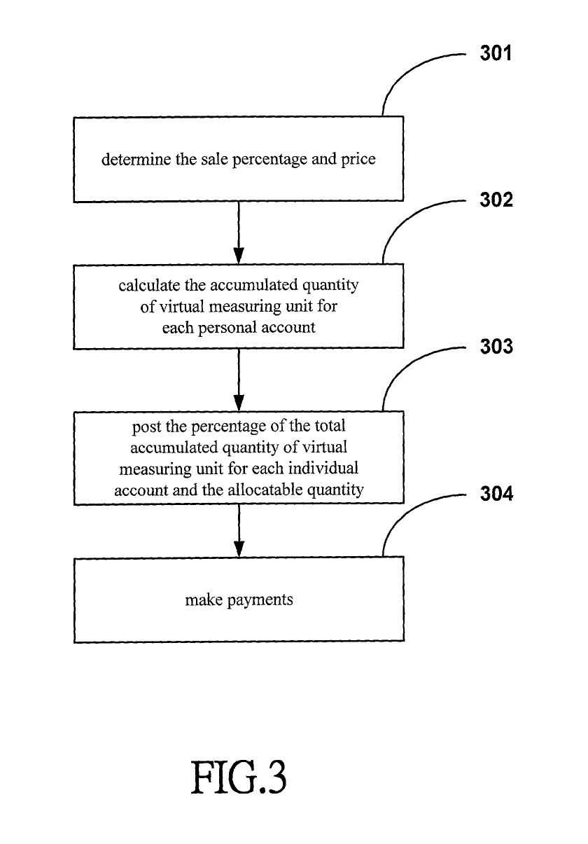

Please refer to FIG. 3, which is the income distribution flow chart in currency unit from the sale of the e-company. When some people want to purchase the network platform, the flow to allocate the interests created are as follows. It is first to determine the sale price 301, and then to calculate the total eNetDollar or points in each respective account 302 and post the percentage of all the accumulated eNetDollar or points for each individual account, the allocatable quantity 303 according to proportion and the actual payment 304 in sales earning according to proportion.

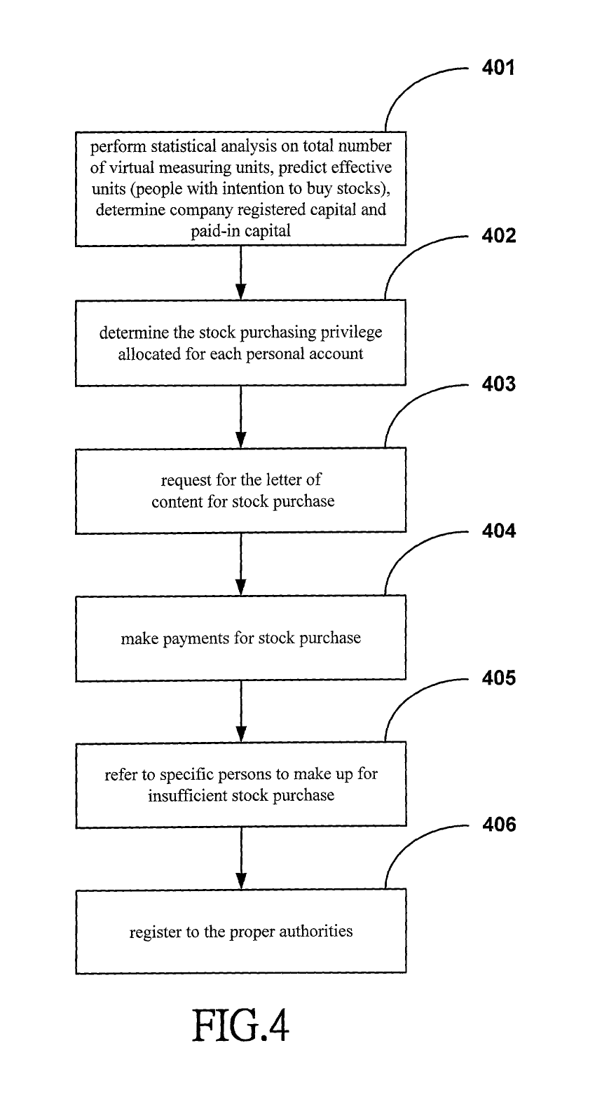

Please refer to FIG. 4, which is the illustration for determining the distribution ratios of stock option when the e-company is registered to IPO. At first, it needs to calculate all the accumulated quantity of eNetDollar or points, and then analyze and predict the valid number of units (number of people with intention to buy company stocks). Determine the company registered capital and paid-in capital 401. Calculate the stock purchasing privilege 402 to be allocated for each individual account. Request the letter of content 403 to purchase stocks. Make payments for stock purchase 404. Refer to specific individuals when insufficient fund raising from selling stocks takes place 405. Finally, register to the proper authorities 406.

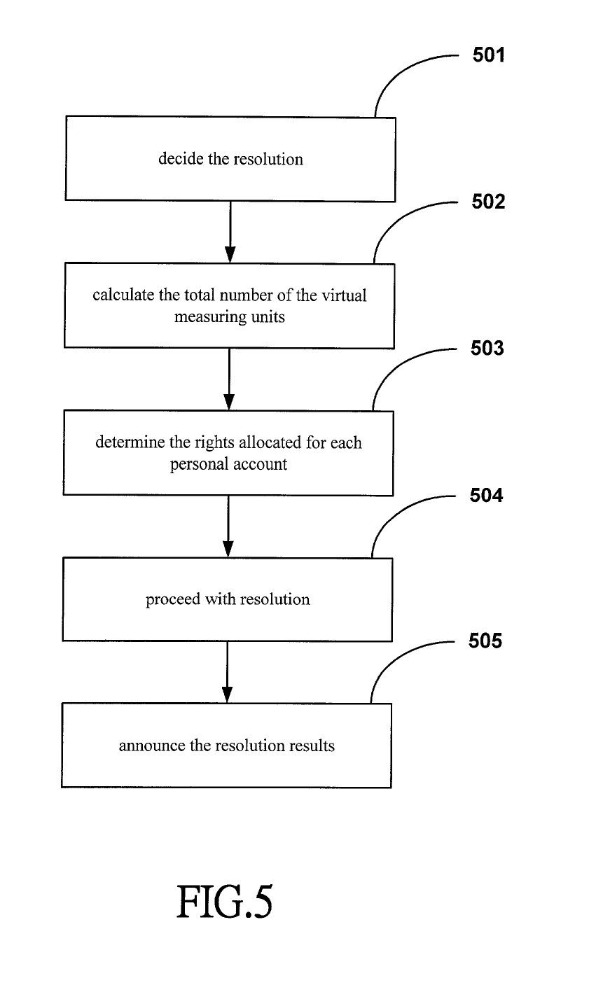

Please refer to FIG. 5, which is the illustration for determining the rights and values when the e-company becomes a network platform with public credibility. When the e-company has issues 501 to be resolved after having a network platform of public credibility due to an operational success, first sum up the quantity of eNetDollar or points 502 and calculate the allocated right and value 503 for each individual account, and then proceed with resolution 504 followed by the announcement of resolution result 505.

Compared to the traditional practice, the present invention that provides a process to collaboratively create value for e-business and equipment therein has the following advantages.

1. The process and the equipment to collaboratively create value for e-business is established upon an interest-sharing idea based on contribution level. The present invention can effectively attract users to log on and browse the contents, put advertisements, provide articles and upload pictures, photos, voices, music, images and other multimedia through a interest-sharing process based on contribution level, to create common interests and realize the dreams.

2. The process and the equipment to collaboratively create value for e-business in the present invention consider all the precipitants as a part of the enterprise. By using the integrated strength, e-business is expected to grow rapidly.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A process and equipment therein to collaboratively create value for e-business, which is an enterprise established on wire or wireless communication framework which value is developed by investors, operators and users, the investors and the operators build the electronic communication environment, wherein the interactions between the users can create the enterprise value, the process will record the contributions from the three parties and allocate the appropriate amount of virtual currency or other measuring units to each sponsor, when the e-company is transformed, sold or has other resolutions, the interests created will be allocated to the three parties according to the proportion of the accumulated quantity of virtual currency or measuring units, so all the three parties can benefit from the mechanism.

2. A process and equipment therein to collaboratively create value for e-business of claim 1, wherein the contributions from the interactions between the users that can collaboratively create value for e-business include communication fee, advertisements, articles, uploaded pictures and photos, voices, music, images or other multimedia etc.

3. A process and equipment therein to collaboratively create value for e-business of claim 1, wherein the virtual currency in the process and the equipment that can collaboratively create value for e-business can be called eNetDollar (eNet$, |$\e|) or other measuring units.

4. A process and equipment therein to collaboratively create value for e-business of claim 1, wherein the virtual currency in the process and the equipment that can collaboratively create value for e-business can be deposited into a personal account on the network platform in the form of eNetDollar (eNet$) or other measuring units and is subject to ranking and evaluation.

5. A process and equipment therein to collaboratively create value for e-business of claim 1, wherein the practical interests in the process and the equipment that can collaboratively create value for e-business include currency, stock purchasing privilege (including other interests created) and resolution rights etc.

6. A process and equipment therein to collaboratively create value for e-business of claim 1, wherein in the process and the equipment that can collaboratively create value for e-business, the ratio of operation results including currency, stock purchasing privilege (including other interests created) and resolution rights to the investment is called Earn Per Dream (EPD).
